(19) United States
(12) Patent Application Publication
(10) Pub. No.: US 2026/0356261 A1
(43) Pub. Date: Nov. 12, 2026

(54) VEHICLE SEAT

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US)

(73) Assignee: Ford Global Technologies, LLC, Dearborn, MI (US)

(21) Appl. No.: 19/199,819

(22) Filed: May 6, 2025

(51) Int. Cl. B60N 2/427; B60N 2/42; B60N 2/72

(52) U.S. Cl. CPC B60N 2/42763; B60N 2/4221; B60N 2/72

(57) ABSTRACT

A vehicle seat bottom includes a frame including a seat pan. The frame includes a crossmember spaced seat-rearward from the seat pan. The crossmember is elongated along a cross-seat axis. A spring is engaged with the crossmember. The spring is supported by the seat pan and the crossmember. The spring extends from the seat pan to the crossmember. The spring includes at least two segments elongated in a direction from the seat pan to the crossmember. The segments of the spring are spaced from each other along the cross-seat axis. A bar is supported by and fixed to the spring adjacent the crossmember. The bar is elongated along the cross-seat axis. An actuator is fixed to the frame. The actuator is operatively connected to the bar to pull the bar downwardly and disengage the spring from the crossmember.

### BACKGROUND

A vehicle seat is disposed in an occupant cabin of a vehicle to support an occupant during operation of the vehicle. The vehicle seat includes a seat bottom and a seatback. The seat bottom has a pelvis area that supports the pelvis of the occupant.

The vehicle includes a seatbelt assembly for each occupant to control the kinematics of the occupant relative to the seat in response to a vehicle deceleration caused by the vehicle impact. The seatbelt assembly includes a lap belt that extends across the lap of the occupant when buckled. During certain vehicle impacts, the pelvis of the occupant may be forced in a downward direction in compression against the pelvis area of the seat bottom and away from the lap belt of the seatbelt assembly.

### BRIEF DESCRIPTION OF THE DRAWINGS

FIG. 1A is a side view of a vehicle seat.

FIG. 1B is the side view of FIG. 1A after an actuator has pulled down a spring of the vehicle seat.

FIG. 2 is a perspective view of the vehicle seat.

FIG. 3 is another perspective view of the vehicle seat with a cushion of the seat bottom removed for illustrative purposes.

FIG. 3A is a magnified view of FIG. 3.

FIG. 4 is a perspective view of the vehicle seat after the actuator has pulled down the spring of the vehicle seat.

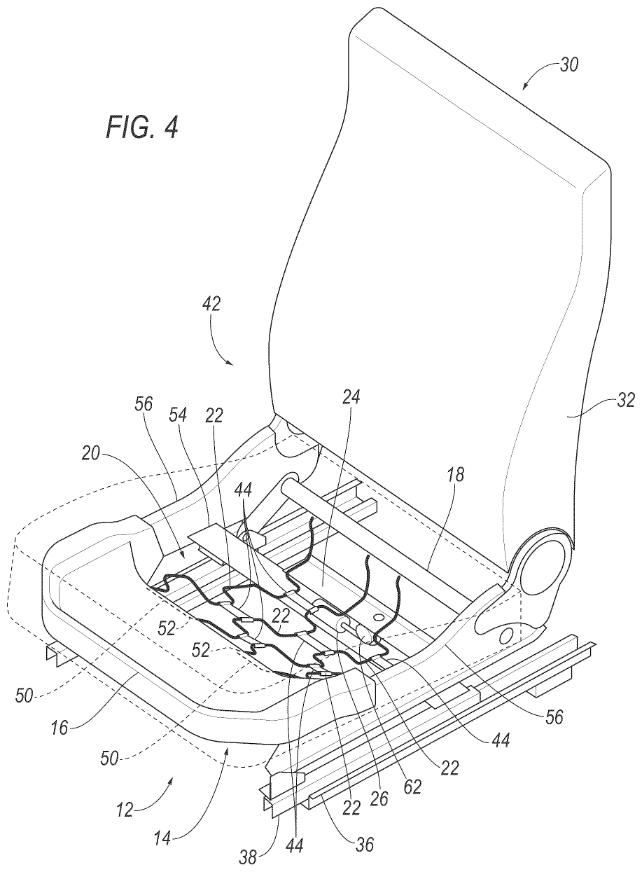

### DETAILED DESCRIPTION

With reference to the Figures, wherein like numerals indicate like parts throughout the several views, a seat bottom 12 of a vehicle 10 includes a frame 14 including a seat pan 16. The frame 14 includes a crossmember 18 spaced seat-rearward from the seat pan 16. The crossmember 18 is elongated along a cross-seat axis CA. A spring 20 is engaged with the crossmember 18. The spring 20 is supported by the seat pan 16 and the crossmember 18. The spring 20 extends from the seat pan 16 to the crossmember 18. The spring 20 includes at least two segments 22 elongated in a direction from the seat pan 16 to the crossmember 18. The segments 22 of the spring 20 are spaced from each other along the cross-seat axis. A bar 24 is supported by and fixed to the spring 20 adjacent the crossmember 18. The bar 24 is elongated along the cross-seat axis. An actuator 26 is fixed to the frame 14. The actuator 26 is operatively connected to the bar 24 to pull the bar 24 downwardly and disengage the spring 20 from the crossmember 18.

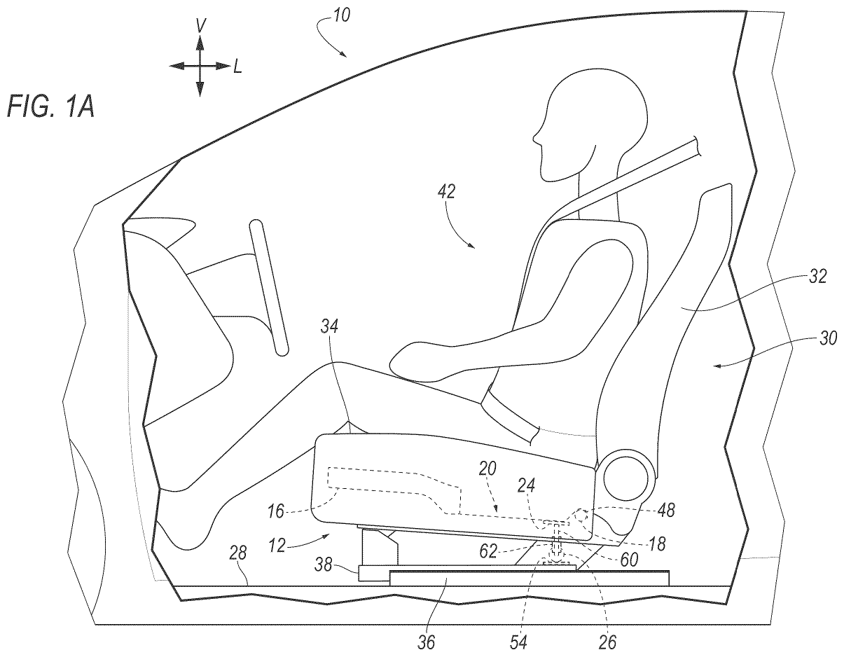

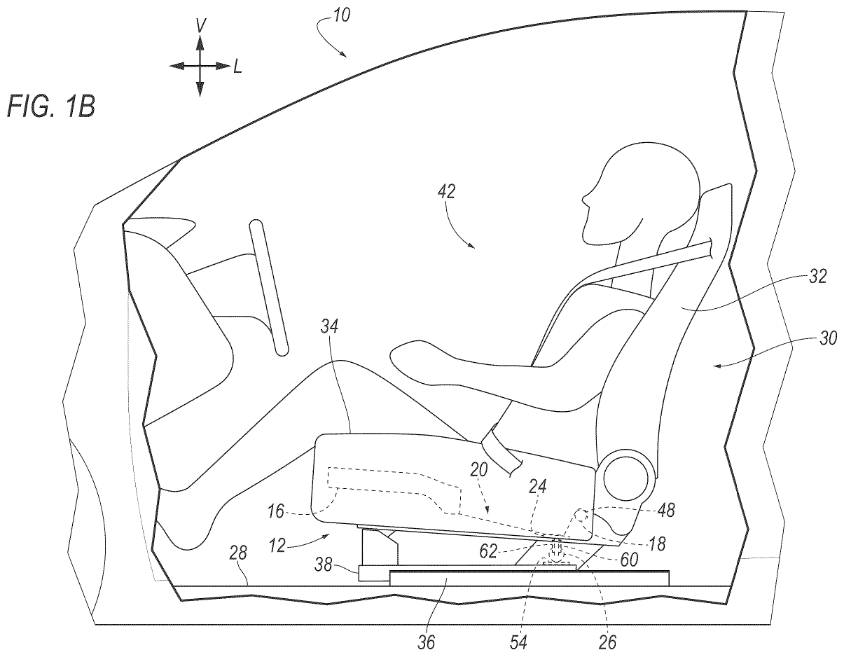

The actuator 26, being fixed to the frame 14, moves as a unit with the frame 14 when the position of the seat 30 is adjusted in the vehicle 10. Since the bar 24 is adjacent the crossmember 18, in the event the actuator 26 pulls the bar 24 down, the bar 24 pulls the spring 20 down below the rear part of the thigh of the occupant to lower the torso of the occupant downwardly, as shown in FIG. 1B.

The vehicle 10 may be any suitable type of automobile, e.g., a passenger or commercial automobile such as a sedan, a coupe, a truck, a sport utility vehicle, a crossover vehicle, a van, a minivan, a taxi, a bus, etc. The vehicle 10 includes a vehicle frame. The vehicle frame may be of a unibody construction in which the frame is unitary with a vehicle body (including frame rails, pillars, roof rails, etc.). As another example, the body and frame may have a body-on-frame construction (also referred to as a cab-on-frame construction) in which the body and frame are separate components, i.e., are modular, and the body is supported on and affixed to the frame. Alternatively, the frame and body may have any suitable construction. The frame and body may be of any suitable material, for example, steel, aluminum, and/or fiber-reinforced plastic, etc.

The vehicle 10 defines a vehicle-longitudinal axis L extending between a front end and a rear-end of the vehicle 10. The vehicle 10 defines a cross-vehicle axis C extending cross-vehicle from one side to the other side of the vehicle 10. The vehicle 10 defines a vertical axis V extending through a floor 28 and roof of the vehicle 10. The vehicle-longitudinal axis L, the cross-vehicle axis C, and the vertical axis V are perpendicular relative to each other.

The vehicle body includes a floor 28 and may include a roof. The roof may define the upper boundary of a passenger compartment of the vehicle 10. The floor 28 is below from the roof. The floor 28 may define the lower boundary of the passenger compartment.

With reference to FIGS. 1A-1B, the vehicle 10 includes one or more seats 30. The vehicle 10 may include any suitable number of seats 30. The seats 30 may be arranged in the passenger cabin in any suitable position, i.e., as front seats, rear seats, third-row seats, etc. The seat 30 may be movable relative to the floor 28 to various positions, e.g., movable fore-and-aft and/or cross-vehicle. The seats 30 may be of any suitable type, e.g., a bucket seat 30. In the example shown in the figures, the seat 30 is shown as a front driver seat 30 as an example, and in other examples, the seat 30 may be in other positions in the vehicle 10 and/or the vehicle 10 may include one or more of the seats 30 including the features described herein.

The seat 30 includes a seatback 32 and a seat bottom 12. The seatback 32 may be supported by the seat bottom 12 and may be stationary or movable relative to the seat bottom 12. The seatback 32 and the seat bottom 12 may be adjustable in multiple degrees of freedom. Specifically, the seatback 32 and the seat bottom 12 may themselves be adjustable, in other words, adjustable components within the seatback 32 and/or the seat bottom 12, and/or may be adjustable relative to each other.

The seat 30 includes a frame. Specifically, the seat bottom 12 has a frame 14 and a seatback 32 has a frame. In some examples, the frame of the seatback is connected to and supported by the frame 14 of the seat bottom 12. The frame of the seat, including the frame 14 of the seat bottom 12, may include tubes, beams, etc. In some examples, some or all components of the frame of the seat 30 may be of any suitable plastic material, e.g., carbon fiber reinforced plastic (CFRP), glass fiber-reinforced semi-finished thermoplastic composite (organosheet), etc. In other examples, some or all components of the frame 14 may be a suitable metal, e.g., steel, aluminum, etc.

The frame 14 of the seat bottom 12 is designed to support an occupant of the seat 30. The frame 14 of the seat bottom 12 extends seat forward from the seatback 32 to support the legs of the occupant. The frame 14 of the seat bottom 12 may include components along the fore-and-aft axis FA and components elongated along the cross-seat axis CA. In the example shown in the Figures, the frame 14 of the seat bottom 12 includes lateral members 56 elongated along the fore-and-aft axis FA and crossmembers 18 elongated along the cross-seat axis CA and fixed to the lateral members 56. As an example, in the example shown in the Figures, the frame 14 of the seat bottom 12 includes two crossmembers 18, specifically, the seat pan 16 and the crossmember 18 spaced seat-rearward from the seat pan 16. The seat pan 16 and the crossmember 18 are elongated along the cross-seat axis CA. The seat pan 16 may be designed to (i.e., sized, shaped, and contoured to, support the thighs of the occupant at the knees. The crossmember 18 may be at a rear end of the seat bottom 12 along the fore-and-aft axis FA adjacent the seatback 32. In some examples, the crossmember 18 may be directly beneath the seatback 32.

The seat 30 includes a cushion 30 supported on the frame 14 of the seat bottom 12. In some examples, the seatback 32 includes a separate cushion supported on the frame 14 of the seat bottom 12. In some examples, the cushion 34 includes upholstery and padding. The upholstery may be cloth, leather, faux leather, or any other suitable material. The upholstery may be stitched in panels around the frame 14. The padding may be between the upholstery and the frame 14 and may be foam or any other suitable material. The cushion 30 is flexible relative to the spring 20 and the frame 14 such that, in the event the spring 20 is released from the crossmember 18 by the actuator 26, the weight of the occupant on the cushion 30 deforms the cushion downwardly so that the occupant sinks into the seat bottom 12.

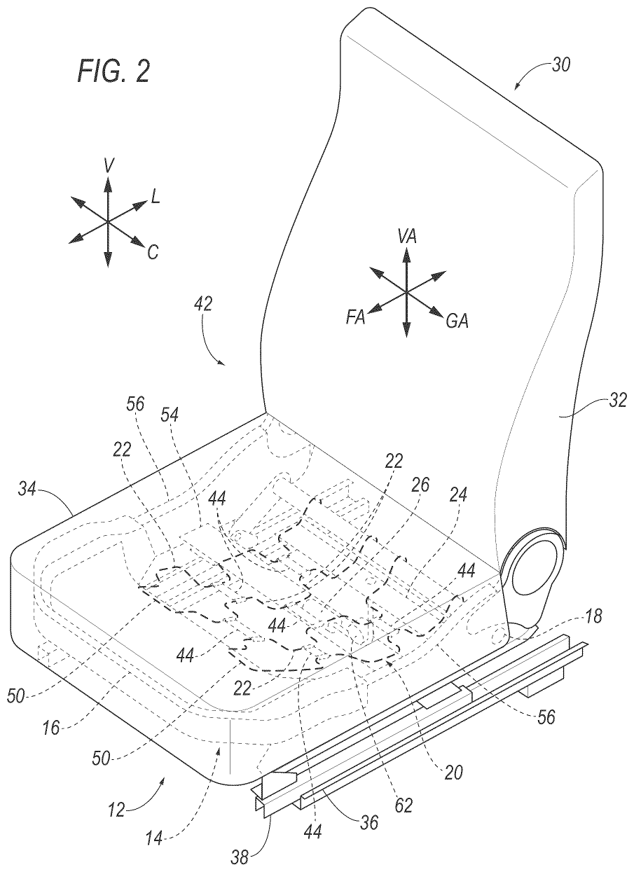

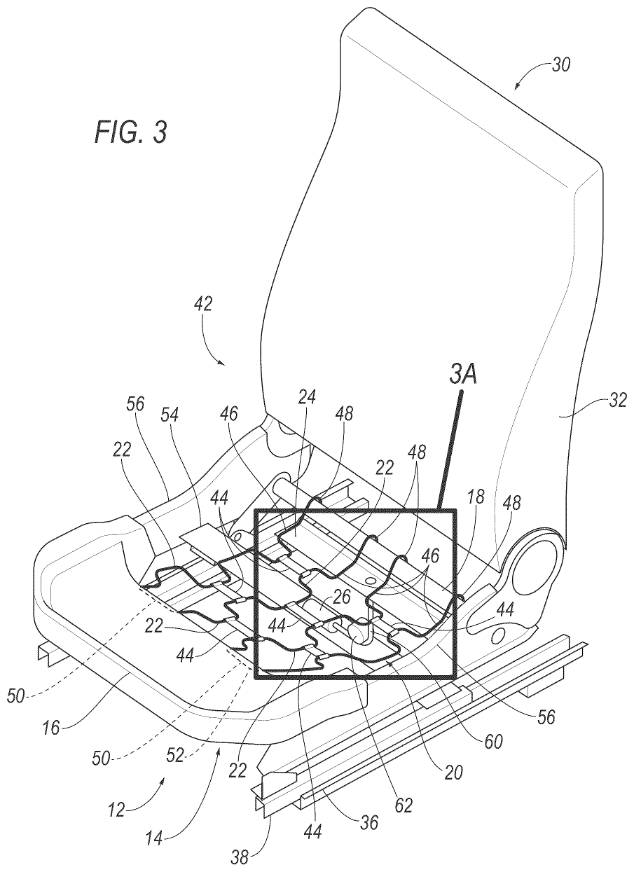

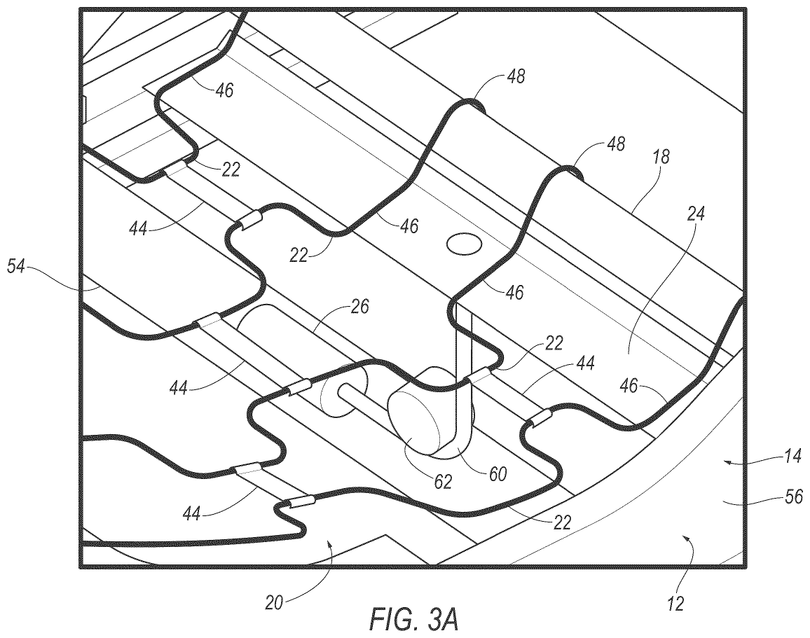

With reference to FIGS. 2-3, the seat 30 includes a seat track 36 for allowing adjustment of the seat bottom 12 relative to the body of the vehicle 10. In the example shown in the Figures, the seat track 36 allows for adjustment of the seat bottom 12 relative to the floor 28 of the vehicle 10 along the vehicle-longitudinal axis L. In the example shown in the Figures, the seat bottom 12 includes sliders 38 slidably engaged with the seat track 36. The sliders 38 may be components of the frame 14 of the seat bottom 12 and/or may be fixed to the frame 14 of the seat bottom 12. The sliders 38 may be selectively movable and selectively lockable relative to the seat tracks 36 by way of, for example, motorized control, operation of a manual mechanical release, etc. The frame 14 of the seat bottom 12, the spring 20, the bar 24, and the actuator 26 are moveable as a unit relative to the sliders 38. Specifically, as the sliders 38 slide along the track 36, the frame 14 of the seat bottom 12, the spring 20, the bar 24, and the actuator 26 move as a unit relative to the track 36.

The seatback 32 defines an occupant-seating area 42. The occupant-seating area 42 is the space occupied by an occupant properly seated on the seat 30. The occupant-seating area 42 is seat-forward of the seatback 32 and above the seat bottom 12.

The seat 30 defines a fore-and-aft axis FA, a cross-seat axis CA, and a vertical axis VA. The seat 30 defines the seat-forward direction along the fore-and-aft axis FA. The seat-forward direction may extend from a rear of the seat bottom 12, e.g., at the seatback 32, to a front of the seat bottom 12 relative to an occupant of the seat 30, i.e., the occupant of the seat 30 faces in the seat-forward direction when properly seated in the seat 30. The seat bottom 12 extends from the seatback 32 in the seat-forward direction. A cross-seat direction extends along the cross-seat axis CS. The fore-and-aft axis FA, the cross-seat axis CS, and the vertical axis VA are perpendicular to each other. The fore-and-aft axis FA is parallel with the vehicle-longitudinal axis L when the seat 30 is forward facing in the passenger compartment. The cross-seat axis CS is parallel with the cross-vehicle axis C when the seat 30 is forward facing and when the seat 30 is rearward facing. The seat-upright axis SU extends through the vehicle floor 28 and the vehicle roof when the seatback 32 is in an upright position.

The seat 30 includes a first side and a second side. The first side is spaced from the second side along the cross-seat axis CS. In the example shown in the Figures, when the seat 30 is in a forward-facing position, the second side of the seat 30 is vehicle-inboard of the first side of the seat 30, and the first side of the seat 30 is vehicle-outboard of the second side of the seat 30.

The vehicle 10 includes seatbelt assemblies for each of the seats 30, as shown in FIGS. 1A and 1B. A portion of an example seatbelt assembly is shown in FIGS. 1 and 2. The seatbelt includes webbing that, when the seatbelt is buckled, extends across an occupant of the seat 30. The webbing feeds into a retractor, which includes a spool that pays out and retracts the webbing. A clip slides freely along the webbing and, when engaged with a buckle, divides the webbing into a lap band and a shoulder band.

The spring 20 is designed to (i.e., sized, shaped, positioned, material selection, etc.) support an occupant on the seat 30 between the seat pan 16 and the crossmember 18, i.e., the weight of the occupant is borne by the spring 20. An occupant of the seat 30 is supported by the spring 20 between the seat pan 16 and the crossmember 18. Specifically, the thighs of the occupant are supported by the spring 20, as shown in FIGS. 1A-1B. In examples including the cushion 34, the cushion 34 is supported by the spring 20, i.e., the weight of the cushion 34 is borne by the spring 20. The cushion 34 may directly contact the spring 20.

In some examples, including the example shown in the Figures, the spring 20 includes multiple segments 22. With reference to FIGS. 2-3A, the segments 22 are spaced from each other along the cross-seat axis AC. In the example shown in the Figures, the spring 20 includes four segments 22 spaced from each other along the cross-seat axis AC. In the example shown in the Figures, two of the segments 22 are connected to each other by a pan hook 50 unitary with the two segments 22. Some of the segments 22 may be connected to each other with lateral connectors 44 extending from one segment 22 to another segment 22 along the cross-seat axis, as shown in the example in the Figures. In the example shown in the Figures, the lateral connectors 44 are formed separately from and connected to the segments 22. In other examples, the segments 22 and the lateral connectors 44 may be unitary, i.e., formed together as a single unit. In some examples, the segments 22 may be metal, e.g., steel. In examples including lateral connectors 44, the lateral connectors 44 may be plastic, metal, or any suitable material.

The segments 22 may be elongated in a direction from the seat pan 16 to the crossmember 18. The segments 22 may have a zig zag shape in a generally horizontal plane (i.e., the plane on which the thighs of the occupant are supported). In such examples, the longest dimension of the segment 22 is in a direction from the seat pan 16 to the crossmember 18, i.e., in such examples the segments 22 are elongate in the direction from the seat pan 16 to the crossmember 18.

The spring 20 is supported by the seat pan 16 and the crossmember 18. In other words, the weight of the spring 20 is borne by the seat pan 16 and the crossmember 18. In the example shown in the Figures, the spring 20 extends from the seat pan 16 to the crossmember 18 and, in such examples, the spring 20 is engaged with the crossmember 18 and the seat pan 16. In such examples, the spring 20 contacts the crossmember 18 and the seat pan 16 with a direct connection 46. In other examples, the spring 20 may be indirectly coupled to the seat pan 16 through one or more intermediate components.

The spring 20 may include one or more crossmember hooks 48 engaging the crossmember 18. When engaged with the crossmember 18, the crossmember hook 48 supports the segments 22 on the crossmember 18. The crossmember hook 48 rests on a top surface of the crossmember 18 to support the crossmember hook 48 on the top surface. The crossmember hook 48 receives the crossmember 18. Specifically, the crossmember hook 48 is sized and shaped to receive the crossmember 18. In the example in the Figures, the crossmember 18 has a round cross section and the crossmember hook 48 had a round shape that matches the round cross section of the crossmember 18.

In the example shown in the Figures, each of the segments 22 includes a crossmember hook 48. In other examples, one or more of the segments 22 but less than all of the segments 22 may include the crossmember hook 48. In such examples, the crossmember hook 48(s) support all of the segments 22 on the crossmember 18.

In the example shown in the Figures, each crossmember hook 48 is unitary with a respective one of the segments 22, i.e., the crossmember hook 48 and segment 22 are a single, uniform piece of material with no seams, joints, fasteners, or adhesives holding them together. In such an example, the crossmember hook 48 and the segment 22 are formed together simultaneously as a single continuous unit, e.g., bending a unitary blank, molding, etc. Non-unitary components, in contrast, are formed separately and subsequently assembled, e.g., by welding, adhesive, bonding, welding, etc.

The spring 20 may include one or more pan hooks 50 that engage the seat pan 16. In the example shown in the Figures, two of the segments 22 extend from a common pan hook 50 and the segments 22 are unitary with the respective pan hook 50. The pan hook 50 is designed to engage the seat pan 16. In the example shown in the Figures, the pan hooks 50 extend into corresponding hooks 52 in the seat pan 16.

The spring 20 is designed to deform and release from the crossmember 18 in response to downward pull by the actuator 26. In the example shown in the Figures, the crossmember hook 48 is deformable relative to the crossmember 18 to release from the crossmember 18 in response to downward pull by the actuator 26. In other words, the size, shape, position, material selection, etc., of the crossmember hook 48 results in deformation of the crossmember hook 18 relative to the crossmember 18 when the spring 20 is pulled downwardly by the actuator 26. In the example shown in the Figures, the crossmember hooks 18 bend and straighten when the spring 20 is pulled down by the actuator 26.

The spring 20 is designed to remain supported by the seat pan 16 during downward pull by the actuator 26. In the example shown in the Figures, the spring 20 remains engaged with the seat pan 16 during and after the activation of the actuator 26. Specifically, the pan hooks 50 remain engaged in the holes of the seat pan 16. In FIG. 1B, the pan hooks 50 are engaged with the corresponding hooks 52 of the seat pan 16 while the crossmember hooks 48 are released from the crossmember 18 as a result of the downward pull by the actuator 26.

The crossmember hooks 48 release from the crossmember 18 when the spring 20 is pulled down by the actuator 26 such that the spring 20 is no longer supported by the crossmember 18, and the spring 20 remains supported by the seat pan 16 when the spring 20 is pulled down by the actuator 26. Accordingly, the upper thighs of the occupant of the seat 30 moves downwardly toward the floor 28 of the vehicle 10 while the lower thighs at the knees remain supported by the seat pan 16.

The bar 24 is supported by the spring 20. In other words, the weight of the bar 24 is borne by the spring 20, and specifically, by the segments 22 of the spring 20. In the example shown in the Figures, the spring 20 and the bar 24 are positioned to support the weight of an occupant of the vehicle 10 seat 30.

The bar 24 is adjacent the crossmember 18 such that when the actuator 26 pulls the bar 24 down, force from bar 24 pulls the crossmember hooks 48 to deform the crossmember hooks 48 relative to the crossmember 18. The bar 24 may be directly connected to the crossmember hooks 48, may be between the crossmember hooks 48 and the segments 22, or may be directly connected to the half of the segment 22 extending from the crossmember hook 48.

The bar 24 is fixed to the spring 20. In the example shown in the Figures, the bar 24 is fixed to the segments 22 of the spring 20 at a direct connection 46 between the spring 20 and the bar 24. The spring 20 and the bar 24 abut each other at the direct connection 46, e.g., at direct connection 46s at each of the segments 22 and/or crossmember hooks 48. The direct connection 46 may be, for example, a weld, adhesive, bonding, mechanical attachment, etc. The direct connection 46 between the spring 20 and the bar 24 has a strength to remain intact during release of the hooks relative to the crossmember 18 in response to downward pull by the actuator 26. Specifically, the direct connection 46 between the spring 20 and the bar 24 has a strength to remain intact during deformation of the spring 20 relative to the crossmember 18 in response to downward pull by the actuator 26. In the example shown in the Figures, the hooks deform relative to the crossmember 18 and the direction connection between the spring 20 and the bar 24 remains intact when the actuator 26 pulls the spring 20 down.

The bar 24 may be elongated along the cross-seat axis CA, as shown in the example in the Figures, i.e., the longest dimension of the bar 24 is along the cross-seat axis CA. The bar 24 can be plate shaped, i.e., can be a plate that is flat in a generally horizontal plane.

The bar 24 is rigid relative to the spring 20. Specifically, the bar 24 is rigid relative to the segments 22 of the spring 20. In the event downward force is applied to the bar 24 by the actuator 26, the bar 24 delivers force to the spring 20 to release the spring 20 from the crossmember 18, e.g., by deforming the crossmember hooks 48. The bar 24 may be metal (e.g., steel, aluminum, etc.), plastic (e.g., acrylonitrile butadiene styrene, polypropylene, nylon, etc.) including fiber-reinforced plastic, or any other suitable material. In examples in which the bar 24 and the spring 20 are metal, e.g., steel, the spring 20 may be welded to the bar 24.

The actuator 26 is fixed to the frame 14. As set forth above, the actuator 26 moves as a unit with the frame 14, including when the frame 14 moves relative to the seat track 36. In the example, shown in the Figures, the frame 14 includes a platform 54 fixed to the lateral members 56 of the frame 14, and the actuator 26 is fixed to the platform 54. The platform 54 moves as a unit with the lateral members 56 of the frame 14. The platform 54 may be fixed to the lateral members 56 by welding, mechanical attachment, etc. The actuator 26 may be fixed to the platform 54 my mechanical attachment, e.g., threaded fasteners, brackets, etc.

The actuator 26 is operatively connected to the bar 24 to pull the bar 24 downwardly and disengage the spring 20 from the crossmember 18. As an example, the actuator 26 includes a body 58 fixed to the frame 14 and a cable 60 extending from the body 58 to the bar 24. The cable 60 is fixed to the bar 24, i.e., an end of the cable 60 moves as a unit with the bar 24, and is retractable into the body 58, i.e., another end of the cable 60 is retractable into the body 58, as described further below. The seat 30 may include a pulley 62 engaging the cable 60 between the actuator 26 and the bar 24 to guide the cable 60 and change the direction of the force applied by the actuator 26 to the bar 24. The pulley 62 may be fixed to the platform 54 or any suitable component of the frame 14.

The actuator 26 may be a pyrotechnic actuator 26, e.g., the actuator 26 may include a pyrotechnic retractor and the cable 60 extending from the pyrotechnic retractor to the bar 24. In such an example, the pyrotechnic device includes a pyrotechnic charge. The pyrotechnic charge is activated to activate the pyrotechnic device.

The pyrotechnic charge may be combustible to produce a gas. The pyrotechnic charge may be formed of a solid mixture of substances that, when ignited, react to produce the gas. For example, the pyrotechnic charge may be formed of sodium azide (NaNO3), potassium nitrate (KNO3), and silicon dioxide (SiO2), which react to form nitrogen gas (N2).

The pyrotechnic device may be, for example, a rotary actuator 26 or a linear actuator 26. For example, the pyrotechnic device may be any suitable type such as a rotary actuator 26, in which the pyrotechnic charge rotates a shaft connected to the cable such that the cable wraps around the shaft; a piston linkage, in which the pyrotechnic charge for example, drives a piston attached to the cable; a ball-in-tube linkage, in which an pyrotechnic charge propels a ball or balls over a cogwheel connected to the cable; a mechanical linkage, in which a compressed spring 20 attached to the cable is released; or any other suitable type.

The vehicle 10 includes a computer programmed (i.e., has a processor and memory storing instructions executable b the processor) to activate the pyrotechnic actuator 26 in response to detection of certain frontal vehicle impacts. Use of “in response to,” “based on,” and “upon determining” herein indicates a causal relationship, not merely a temporal relationship.

The vehicle 10 may include at least one impact sensor for sensing certain vehicle impacts (e.g., impacts of a certain magnitude, direction, etc.), and the computer is in communication with the impact sensor and the inflator actuator 26. The computer may activate the actuator 26, e.g., provide an impulse to a pyrotechnic charge of the actuator 26, when the impact sensor senses certain vehicle impacts. The impact sensor may be configured to sense certain vehicle impacts prior to impact, i.e., pre-impact sensing. A “certain vehicle impact” is an impact of the type and/or magnitude for which activation of the actuator 26 is designed i.e., “certain” indicates the type and/or magnitude of the impact. The type and/or magnitude of such “certain vehicle impacts” may be pre-stored in the computer, e.g., a restraints control module. The impact sensor may be of any suitable type, for example, post contact sensors such as accelerometers, pressure sensors, and contact switches; and pre-impact sensors such as radar, LIDAR, and vision sensing systems. The vision sensing systems may include one or more cameras, CCD image sensors, CMOS image sensor, etc.

The numerical adjectives “first,” “second,” etc., are used herein as identifiers and do not indicate order or importance.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle seat bottom comprising:
a frame including a seat pan;
the frame including a crossmember spaced seat-rearward from the seat pan, the crossmember being elongated along a cross-seat axis;
a spring engaged with the crossmember, the spring being supported by the seat pan and the crossmember and extending from the seat pan to the crossmember;
the spring including at least two segments elongated in a direction from the seat pan to the crossmember, the segments being spaced from each other along the cross-seat axis;
a bar supported by and fixed to the spring adjacent the crossmember, the bar being elongated along the cross-seat axis; and
an actuator fixed to the frame and operatively connected to the bar to pull the bar downwardly and disengage the spring from the crossmember.

2. The vehicle seat bottom as set forth in claim 1, wherein the spring includes a hook that receives the crossmember.

3. The vehicle seat bottom as set forth in claim 2, wherein the hook is deformable relative to the crossmember to release from the crossmember in response to downward pull by the actuator.

4. The vehicle seat bottom as set forth in claim 3, wherein the spring is designed to remain supported by the seat pan during downward pull by the actuator.

5. The vehicle seat bottom as set forth in claim 4, wherein the bar is rigid relative to the spring.

6. The vehicle seat bottom as set forth in claim 1, wherein the bar is fixed to the segments of the spring and is rigid relative to the segments of the spring.

7. The vehicle seat bottom as set forth in claim 1, wherein the segments of the spring have a zig zag shape in a generally horizontal plane.

8. The vehicle seat bottom as set forth in claim 1, wherein a direct connection between the spring and the bar has a strength to remain intact during disengagement of the spring from the crossmember in response to downward pull by the actuator.

9. The vehicle seat bottom as set forth in claim 1, further comprising a cushion supported by the spring.

10. The vehicle seat bottom as set forth in claim 1, wherein the spring and the bar are positioned to support the weight of an occupant of the vehicle seat.

11. The vehicle seat bottom as set forth in claim 1, wherein the bar is metal and the spring is welded to the bar.

12. The vehicle seat bottom as set forth in claim 1, wherein the actuator includes a pyrotechnic retractor and a cable extending from the pyrotechnic retractor to the bar.

13. The vehicle seat bottom as set forth in claim 12, further comprising a pulley engaging the cable between the pyrotechnic retractor and the bar.

14. The vehicle seat bottom as set forth in claim 1, further comprising a track, the frame, the spring, the bar, and the actuator being moveable as a unit relative to the track.

15. An assembly comprising:
a frame including a seat pan;
the frame including a crossmember spaced seat-rearward from the seat pan, the crossmember being elongated along a cross-seat axis;
a spring engaged with the crossmember, the spring being supported by the seat pan and the crossmember and extending from the seat pan to the crossmember;
a bar supported by and fixed to the spring with direct connections between the spring and the bar, the bar being elongated along the cross-seat axis; and
the spring and the bar being positioned to support the weight of an occupant;
the spring including at least two segments elongated in a direction from the seat pan to the crossmember, the segments being spaced from each other along the cross-seat axis;
a pyrotechnic actuator fixed to the frame and operatively connected to the bar to pull the bar downwardly and disengage the spring from the crossmember;
a computer programmed to activate the pyrotechnic actuator in response to detection of certain frontal vehicle impacts;
the spring being directly engaged with the crossmember and being designed to deform and release from the crossmember in response to downward pull by the actuator; and
the direct connection between the spring and the bar having a strength to remain intact during deformation of the spring relative to the crossmember in response to downward pull by the pyrotechnic actuator.

16. The assembly as set forth in claim 15, wherein the spring includes a hook that receives the crossmember.

17. The assembly as set forth in claim 16, wherein the hook is deformable relative to the crossmember to release from the crossmember in response to downward pull by the actuator.

18. The assembly as set forth in claim 17, wherein the spring is designed to remain supported by the seat pan during downward pull by the actuator.

19. The assembly as set forth in claim 18, wherein the bar is rigid relative to the spring.

20. The assembly as set forth in claim 15, wherein the bar is fixed to the segments of the spring and is rigid relative to the segments of the spring.
